(19) United States
(12) Patent Application Publication
(10) Pub. No.: US 2005/0210160 A1
(43) Pub. Date: Sep. 22, 2005

(54) [PORTABLE STORAGE DEVICE FOR PERSONALIZING COMPUTER]

(75) Inventors: Horace Chen, TAIPEI (TW); Chin-Cheng Lin, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONIC CORP., Chutung Town, Hsinchu Hsien. (TW)

(21) Appl. No.: 10/907,089

(22) Filed: Mar. 18, 2005

(30) Foreign Application Priority Data
Mar. 22, 2004 (TW) 093107681

(51) Int. Cl. G06F 13/10

(52) U.S. Cl. 710/13

(57) ABSTRACT

The present invention is related to a portable storage device for personalizing computer, wherein an application program is stored in the portable storage device. The portable storage device has a connector for connecting to the connecting port of an electronic device. When the connector and the connecting port are electrically connected, the application program is executed to output the personal profile of the portable storage device to the electronic device, or the personal profile of the electronic device is stored in the portable storage device. Thus, the user can readily change the personal profile in the operating system, so that the task may be accomplished accurately and efficiently, and the problems caused by the operational interface as described in the prior art may be avoided.

This application claims the priority benefit of Taiwan patent application number 093107681 filed on Mar. 22, 2004.

### BACKGROUND OF THE INVENTION

1. Field of the Invention

The present invention relates to a portable storage device for personalizing a computer, wherein a personal profile stored in the portable storage device is output to the electronic device or a personal profile in an operating system of an electronic device stored in the portable storage device. Therefore, the user can readily change the personal profile of any operating system, so that the task may be accomplished accurately and efficiently. Thus, the problems caused by the operational interface may be avoided.

2. Description of Related Art

The advance of technology changed our every day life. For example, ever since the development of personal computer, our daily life activity and working style have changed significantly. A conventional computer is an electrical hardware including, for example, a plurality of electronic components assembled together. In general, the operation of the components requires an operating system.

In the early days, the operating system of personal computer was DOS system. Recently, the DOS system has been replaced by windows system. With the enhancement of the function of the operating system and the modification of the operational interface of the operating system, the user can set corresponding operational interface according to personal habit. Therefore, user's operational speed of computer may be faster, so that operation time may be saved. In the present generation, a variety of tasks and affairs have to be accomplished by computers. However, the exhibition of one's products or the presentation of one's web site is generally accomplished by someone else's computer. When a user uses someone else's computer, it's hard to be acquainted with someone else's computer due to fact that the operational interface is different, so that the operational efficiency is reduced significantly. In a even worse situation, the user can not correctly present the user's idea to others, for example, if a salesman can not precisely and efficiently present the products to the clients, the clients may not feel comfortable with the salesman, or even the business may be catastrophic even though the products is excellent. Thus, the business deal between the dealer and the client may fail.

Furthermore, some people need to use more than one computer. Since the function of the operating system is enhanced, the corresponding personal profiles become more complex. Therefore, the users have to set the operational interface of the computer to be used and may waste a lot of time, i.e., the operational efficiency is reduced.

As described above, how to solve the foregoing conventional problems and disadvantages is important to the manufacturers in the field.

### SUMMARY OF THE INVENTION

According to an aspect of the present invention, a portable storage device for storing an application program is provided. The application program may be used for outputting the personal profile of the portable storage device, or the personal profile may be stored in the portable storage device. Therefore, a user can carry the storage device, and convert the operational interface of any electronic device that the user intent to use into an operational interface that the user acquainted with by using the storage device. Thus, the task can be accomplished accurately and efficiently, and the problems caused by the operational interface described above can be avoided.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram according to one embodiment of the present invention.

FIG. 2 is a flowchart of a process according to one embodiment of the present invention.

FIG. 3 is a schematic block diagram according to another embodiment of the present invention.

### DESCRIPTION OF PREFERRED EMBODIMENTS

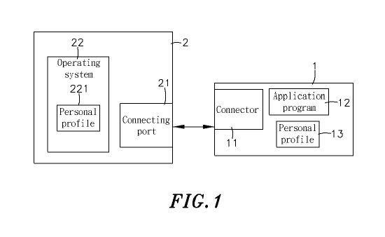

Referring to FIG. 1, the present invention includes a portable storage device 1 and an electronic device 2.

The portable storage device 1 includes a connector 11, and an application program 12 and a personal profile 13 can be stored in the portable storage device 1.

The electronic device 2 includes a connecting port 21 and an operating system 22, and a personal profile 221 can be stored in the operating system 22.

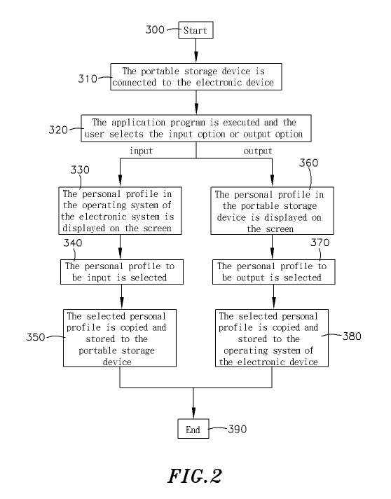

Referring to FIG. 2, the operation of the portable storage device for personalizing a computer of the present invention is performed by the following steps.

At step (300), the portable storage device is started.

At step (310), the connector 11 of the portable storage device 1 is connected to the connecting port 21 of the electronic device 2.

At step (320), the application program 12 is executed, and the application program 12 may display output option or input option on a screen connected to the electronic device 2. If the user selects the input option, step (330) will be executed. Alternatively, if the user selects output option, step (360) will be executed.

At step (330), the personal profile 221 in the operating system 22 of the electronic device 2 is displayed on the screen connected to the electronic device 2.

At step (340), the personal profile 221 to be input is selected.

At step (350), the selected personal profile 221 is copied and stored to the portable storage device 1 via the connecting port 21 and the connector 11, then step (390) is executed.

At step (360), the personal profile 13 stored in the portable storage device 1 is displayed on the screen connected to the electronic device 2.

At step (370), the personal profile 13 to be input is selected.

At step (380), the selected personal profile 13 is copied and stored to the operating system 22 of the electronic device 2 via the connecting port 21 and the connector 11.

At step (390), the procedure ends.

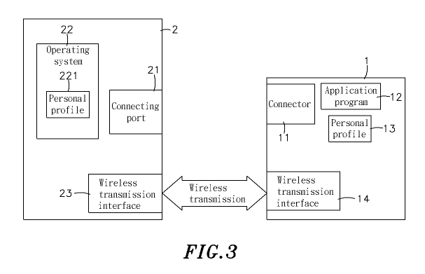

Referring to FIG. 3, a wireless transmission interface 14 is further disposed in the portable storage device 1, and a wireless transmission interface 23 is further disposed in the electronic device 2. The wireless data transfer between the portable storage device 1 and the electronic device 2 may be performed by the wireless transmission interfaces 14 and 23.

Furthermore, the portable storage device 1 of the present invention can be a portable disk, a memory card or a mini hard disk. The electronic device 2 can be a computer or a personal digital assistant (PDA). In addition, the connector 11 of the portable storage device 1 and the connecting port 21 of the electronic device 2 can be universal serial bus (USB) connector or IEEE 1394 connector.

Furthermore, the personal profile 221 can be a personal password, calendar, address book, my favorite network setting and so on.

As described above, the advantages of the portable storage device for personalizing a computer include, for example, the portable storage device 1 for storing the application program 12. In addition, the application program 12 can be provided for outputting the personal profile 13 in the portable storage device 1 to the electronic device 2, or the personal profile 221 of the electronic device 2 can be stored in the portable storage device 1. Therefore, the user can carry the portable storage device 1, and use the portable storage device 1 to transform the operational interface of any electronic device 2 to be used into an operational interface the user acquainted with. Thus the task can be accomplished accurately and efficiently, and the problems caused by the operational interface in the prior art can be avoided.

The detail description of the present invention described above is provided for illustrating some exemplary embodiment of the present invention. It should be noted that, these embodiments can not be used to limit the scope of the present invention. In addition, any equivalent variation and modification corresponding to the scope of the technology of the present invention are also included in the scope of the claim of the present invention.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A portable storage device, for personalizing a computer, wherein an application program is stored in the portable storage device, the portable storage device comprising a connector, for electrically connecting to a connecting port of an electronic device so that the application program is provided for outputting a personal profile of the portable storage device to the electronic device, or a personal profile stored in the electronic device stored in the portable storage device, such that the personal profile of the operating system is changed, and time for setting the personal profile in the electronic device is reduced.

2. The portable storage device of claim 1, wherein the application program is automatically executed as the connector and the connecting port are electrically connected.

3. The portable storage device of claim 1, wherein the portable storage device further comprises a wireless transmission interface.

4. The portable storage device of claim 1, wherein the electronic device further comprises a wireless transmission interface.

5. The portable storage device of claim 1, wherein the portable storage device comprises a portable disk.

6. The portable storage device of claim 1, wherein the portable storage device comprises a memory card.

7. The portable storage device of claim 1, wherein the portable storage device comprises a mini hard disk.

8. The portable storage device of claim 1, wherein the electronic device comprises a computer.

9. The portable storage device of claim 1, wherein the electronic device comprises a personal digital assistant (PDA).

10. The portable storage device of claim 1, wherein the personal profile comprises an address book.

11. The portable storage device of claim 1, wherein the personal profile comprises a personal password.

12. The portable storage device of claim 1, wherein the personal profile comprises a calendar.

13. The portable storage device of claim 1, wherein the connector comprises a universal serial bus (USB) connector.

14. The portable storage device of claim 1, wherein the connector comprises an IEEE 1394 connector.
